(19) United States
(12) Patent Application Publication
(10) Pub. No.: US 2017/0110088 A1
(43) Pub. Date: Apr. 20, 2017

(54) Customizable Extreme Low Power Consumption Apparels

(71) Applicant: Leta Dickinson, Cupertino, CA (US)

(72) Inventor: Leta Dickinson, Cupertino, CA (US)

(21) Appl. No.: 15/297,147

(22) Filed: Oct. 19, 2016

Related U.S. Application Data
(60) Provisional application No. 62/243,155, filed on Oct. 19, 2015.

(51) Int. Cl. G09G 5/04; G09G 3/20; G09G 3/34; A43B 1/00; A41D 3/00; A41D 1/14; A41F 9/00; A43B 3/00; G06F 1/16; A41D 27/08

(52) U.S. Cl. CPC G09G 5/04; G06F 1/1652; G09G 3/2096; G09G 3/3453; A41D 27/085; A41D 3/00; A41D 1/14; A41F 9/002; A43B 3/0005; A43B 1/0027; G09G 2370/06; G09G 2370/16; G09G 2330/021

(57) ABSTRACT

The present invention provides a customizable apparel apparatus with its color, pattern, and theme modifiable easily and frequently. Using flexible display material for apparel cover in one of the embodiments enables customer to design their apparel pattern and change the pattern whenever they want to by transmitting their own design to the apparel cover via wired connections or wireless connections. As the flexible display material become ever more prevailing, this is a much lower cost approach for consumer to obtain clothing, shoes, hats, backpacks, belts, and other accessories in different color or pattern. This invention simplifies the mechanism of customizing apparel and enables the apparel wearer to modify her apparel to fit her occasion or express herself through her own designs. In addition, the present invention does not require a battery for constant energy supply which is safer for the wearer and better for environment.

### CROSS REFERENCE OF RELATED APPLICATIONS

The present application claims the benefit of U.S. Provisional Application No. 62/243,155, filed on Oct. 19, 2015 entitled “CUSTOMIZABLE LOW POWER CONSUMPTION APPARELS”, which is hereby incorporated by reference in its entirety.

### STATEMENT REGARDING FEDERALLY SPONSORED RESEARCH OR DEVELOPMENT

None.

### BACKGROUND OF THE INVENTIONS

This invention relates generally to customizable apparels, and more specifically, apparels that can be customized frequently with no or extremely low power consumption.

Customizable apparels are very helpful and sometimes even necessary in many situations, including but are not limited to, fashion shows, complying with attire requirement at special occasions, and self-expression. Apparels that can be easily customized frequently, for example on a daily basis, are even more useful, and could facilitate self-expression through one's own design of his/her own apparels. Customizable apparel allows a person to vary the appearance of the same wearable item to suit the specific occasion on that day, or in accordance with his/her particular mood at any specific moment.

Apparels are important to people's lives. As a result, great amount of ideas have been invented by many innovative people since the beginning of humanity, either as necessity to keep one warmer, part of a cultural costume, or a new way of expression. The industry appears to be fully explored and leaves little room for new invention. However, with the rapid advancement of contemporary technology and availability of modern techniques, many previously impossible approaches are now possible, thus creating opportunities for continuous novel inventions in the apparel industry. For example, there are inventions enabling modification of the appearances of apparels or customization of apparels by attaching various decorations on different parts of apparels such as shoes, clothing, or backpacks. Some designs utilize a small video display panel attached to the apparel to customize the appearance of the apparel.

The problem with known customizable apparel is that the change to the appearance is only a relatively minor modification to the apparel while the background of the apparel usually remains unchanged. This makes it difficult to match the customizable apparel to the overall design of the total outfit, either in color, or in theme. For example, if an outfit design requires complete orange color from head to toe, known methods cannot change the color of the entire apparel from non-orange to orange color. If an outfit design theme requires the same pair of shoes to look like green dinosaur feet in one minute and then golden lion feet a few hours later, known customizable apparels are not able to make such changes easily. The known designs with a video display panel attached to apparels usually only cover a small portion of the apparel and thus cannot enable global changes to the entire apparel. In addition, the customized designs on the video display are pre-determined single message which does not allow customization at any moment by the apparel wearer. Another drawback is that most such video display panel require constant power supply and may caught fire or electrical shorts when used for apparels that are constantly exposed to wet or snowy weather conditions, such as shoes or backpacks. A long term adverse but unknown potential drawback is the potential hazardous effects to apparel wearer's health caused by these powered displays. An additional drawback to these video display panel designs is that they may consume large amount of energy, usually require disposal of the battery embedded in the apparel, and thus are not recommended due to environmental concerns.

Therefore, what is needed is a customizable apparel apparatus that can be customized by the apparel wearer easily, to completely change the apparel into a new color, or fit into a new design theme, or display any other customized designs the apparel wearer desires the apparel to appear to others, without the need to continuously power the display, without significant consumption of energy and power, without the need to dispose any batteries embedded in the apparel, and without introducing any health hazard to the apparel wearer.

### BRIEF SUMMARY OF THE INVENTION

The present invention advantageously fills the aforementioned deficiencies by providing a customizable apparel apparatus which color, pattern, and/or theme that can be modified easily and frequently, without constant energy supply. This invention simplifies the mechanism of customizing an existing apparel and enables the apparel wearer to modify his/her apparel to fit his/her occasion or express himself/herself through his/her own designs. In addition, the present invention provides social benefits. This flexibility and ease of change can help an artistic person display his/her artistic ability by showing off her own work on his/her apparel, a shy person to be more outgoing by expressing his/her opinion/feeling through his/her design on her apparel, and therefore could bring positive effects to the society.

The present invention relates to apparels that can be customized frequently. The apparel (for example, a shoe, backpack, tie, hat, jacket, pair of pants, skirt, glove, mitten, shirt, vest, scarves, glasses, ear plug, smartphone, laptop, PC, portion or all of window/door/wall, drapery/curtain, UE device, book, wallet, purse, belt, hand-bag, suit case, hair-clip, decoration pin, fanny-pack, ear ring, bracelet, necklace, ring, pen, etc) is covered by, or its cover being made of, a flexible display material that can bend easily with the shape of the apparel. The flexible display material could be either completely in one piece or consists of a few sections. In some cases, the flexible display material could be slightly stretchable, similar to a duct tape. In other cases, the flexible display material could be coated with thin clear coating to protect it from wet weather and make it easier to clean. The display material is attached to the apparel via various means. The flexible display material could have one side (for example, bottom side) being coated with something that will enable it to attach to the apparel, including but are not limited to glue, Velcro, clip-on, snap on, so that the flexible material will securely and smoothly adhere to the surface of an apparel when pressed on. In some embodiments, the display material is the apparel itself. The apparel could be accompanied by multiple sets of similarly shaped flexible display materials with pre-determined design or blank background color so that the apparel wearer can add new patterns onto it.

With the advancement of modern flexible display technology, the material for the cover can be made of such flexible display materials, including but are not limited, to e-ink materials that can maintain its color and pattern without any electrical power supply, flexible LCD material, flexible OLED material, flexible LED material, MEMS display material, micro-mirror display material, photoluminescence display material, electrophoretic display material, or other display materials. For some display materials such as e-ink display material, electrical power is only needed when the pattern on the cover needs to be altered into another pattern or another color. Such materials are cheaper and easier and thus are ideal to be used as the cover material for this invention. Other suitable materials could be flexible display materials that change their patterns or colors when a magnetic field is applied onto the surface, or when an electrical field is applied to the surface, or when a current is passed through the material, or when various amount of pressure is applied onto the display surface. These electrical, magnetic, current or other forces can be applied to the surface of the apparel cover manually or by an externally controlled apparatus to apply these forces. For example, current flow, electrical, or magnetic field can be applied when the display backplane circuits are connected with an electrical power supply. This power supply can come from a power outlet, batteries, or solar cells connected to or detached from the display material.

In one particular embodiment of the present invention, a pair of shoes could come with many sets of similarly shaped flexible display covers that easily adhere to a shoe surface like duct tapes, some sets have prior designs, and some sets have single colors or simple backgrounds. Each set includes one or more pieces of cover for each shoe. In one embodiment, the set includes two pieces for the left foot and an additional two pieces for the right foot. For each foot, one piece covers the surface of the back portion of the shoe up to the middle of the sides, and the other piece covers the surface of the front portion of the shoe and slightly extends such that it overlaps with the middle of the sides covered by the first piece of the cover. In this case, if a girl wants to wear orange color shoes one day to school to match her outfit, she can make it happen within a few minutes. Her shoes should originally come with many sets of flexible covers, one of the sets comprises of two pieces of flexible cover for each shoe, with the front and back pieces all in bright orange color entirely. She can pick out the set with orange color, press the back piece for her left shoe onto her left shoe smoothly, and then press the front piece for her left shoe onto her left shoe smoothly, followed by pressing on the back piece for her right shoe smoothly, and then pressing on the front piece for her right shoe smoothly. Immediately, she has a pair of bright orange shoe to wear to school! If in the afternoon on that day, she needs to change her shoes into a pair of dinosaur feet to participate in a Halloween party to match her dinosaur costume, she just needs to bring to school the set of cover with dinosaur feet design, press the back piece onto her shoes smoothly, and then press the front piece onto her shoes. Immediately, she has a pair of shoes that look like dinosaur feet. If the equipment needed to switch the pattern and/or color on these pieces is readily available at school, she only needs to bring one set and can connect her piece with the equipment and change the design on the piece on the spot. If such equipment is not readily available, she can change the design at where the equipment is located, be it at home or special stations/kiosks.

In still another embodiment of the present invention, a backpack comes with many sets of similarly shaped flexible display covers that easily adhere to a backpack surface like duct tapes, some sets have prior designs, and some sets have single colors or simple backgrounds. Each set includes one or more pieces of covers. In one embodiment, a set includes six pieces of covers, one piece covers the surface of the back portion of the backpack, one piece covers the front portion of the backpack, one covers the surface of the top portion of the backpack, one covers the surface of the bottom portion of the backpack, and two pieces cover the surfaces of the sides of the backpack. In this case, if a girl wants to carry an orange colored backpack one day to school to match her outfit, she can make it happen within a few minutes. Her backpack originally should come with many sets of flexible covers, one of the sets comprises of six pieces, all in bright orange color entirely. She can pick out the cover set in orange color, pressing each of the six pieces for her backpack onto the surfaces of her backpack smoothly. Immediately, she has a backpack with bright orange color to carry to school! If in the afternoon on that day, she needs to change her backpack to green color to participate in a Halloween party to match her dinosaur costume, she just needs to bring to school the set of cover with green color for her backpack, pressing each of the six pieces onto her backpack smoothly. Immediately, she has a green backpack with a color that goes with her dinosaur costume! If the equipment needed to switch the pattern and/or color on these pieces is readily available at school, she only needs to bring one set and can connect her piece with the equipment and change the design on the piece on the spot. If such equipment is not readily available, she can change the design at where the equipment is located, be it at home or special stations/kiosks.

In still another embodiment of the present invention, the flexible material cover is attached to the apparel by being sewn onto the surface of the apparel or via other attachment means such as Velcro, clip on, snap on, etc. With the advancement of modern flexible display technology, the material for the cover can be made of such flexible display materials, including but are not limited, to e-ink paper that can maintain its color and pattern without any electrical power supply, flexible LCD material, flexible OLED material, flexible LED material, MEMS display material, micro-mirror display material, or other display materials. For some flexible display materials, such as e-ink paper, electrical power is only needed when the pattern on the cover needs to be altered into another pattern or another color. Other suitable materials could be flexible display materials that change their patterns or colors when a magnetic field is applied onto the surface, or when an electrical field is applied to the surface, or when a current is passed through the material, or when various amount of pressure is applied onto the display surface.

In still another embodiment of the present invention, the flexible display material for the apparel cover is made of e-ink paper sitting on top of a flexible plastic backplane which may include electrical circuits for the purpose of driving the e-ink pixels. Ordinarily the apparel cover is not connected with any power supply and therefore the original pattern on the cover remains unchanged. If a user would like to change the design on her apparel cover, she first connects the apparel cover temporarily with an external power source. Then, the design for the e-ink patterns can be transmitted to the e-ink cover through various communication channels, such as through wired connection, or wireless connection. The user is able to design customized patterns for the apparel cover using computing devices, such as work stations, personal computers, laptops, netbooks, touchpads, notebook computers, PDAs, cell phones, smart phones, smart watches, electronic bracelets, or other devices with computing capability. After user is satisfied with her design, she can transmit her design to the apparel cover, which is now connected with a power source that drives the electrical circuit controlling the pixels in order to switch each pixel to a state corresponding to the new designed pattern. This power source can be from a wall socket or from a battery. A user can also design various patterns and store them in an external or onboard memory and program the apparel cover to change pattern at certain specific times when power supply is available.

In still another embodiment of the present invention, following the same process as described above, except that instead of using e-ink paper, the display material changes its pattern upon an application of a strong external electrical or magnetic field (or physical pressure) pattern. When the user wants to change the pattern on her apparel cover, she′ll make her design first, then user can put the cover under electrical or magnetic field (or the physical pressure pattern), depending on whether the display material responds to electrical or magnetic force (or physical pressure).

In still another embodiment of the present invention, the display material consists of either LED or OLED material. Battery may be required to provide power supply to the LEDs or OLEDs. Similar as above, user can design her own patterns for the apparel cover and transmit the design to the apparel cover, thus enabling the apparel wearer to change her apparel appearance frequently to fit the specific occasion or her mood or simply to demonstrate her artistic view or post advertisements. She may design the pattern as an automatic response based on her mode at the time detected by a mode detection apparatus.

It is therefore an object of the present invention to provide customizable apparel which can be modified frequently. Using pre-design flexible display covers that come with the apparel in retail store, apparel wearers can easily change the apparel design by pressing a new apparel cover on the surface of the apparel. Alternatively by using flexible display material for apparel cover enables customer to design their own apparel pattern and change the pattern whenever they want to by transmitting their own design to the apparel cover via wired connections or wireless connections. As the flexible display material become ever more prevailing, this is a much lower cost approach for consumer to obtain clothing, shoes, hats, backpacks, belts, and other accessories in different color or pattern.

It is another object of the present invention to provide a convenient platform for people to express their opinions or artistic abilities or advertise products for a company by wearing certain message on their customizable apparels. This will enable shy people to become outgoing because they are more confident wearing their own designs. This could provide a positive impact to the society overall.

The present invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

The invention may take physical form in certain parts and arrangement of parts, a preferred embodiment of which will be described in detail in this specification and illustrated in the accompanying drawings which form a part hereof and wherein:

FIG. 1 is a view in perspective of a shoe covered with colored flexible e-paper.

FIG. 2 is a view in perspective of an electronic circuit that controls the changing design on an apparel.

### DETAILED DESCRIPTION OF THE INVENTION

The present invention is directed to a piece of apparel which can be modified easily and frequently and thus enabling the apparel wearer to easily match her apparel to any specific occasion or to reflect her opinions/mood at the moment.

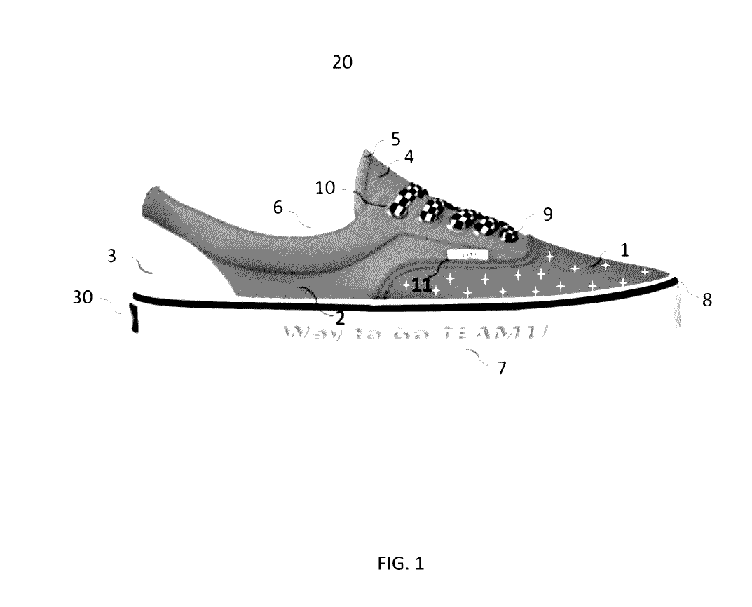

Referring now to the drawings wherein the showings are for purposes of illustrating a preferred embodiment of the invention only and not for purposes of limiting the same, FIG. 1 shows a shoe with a cover, identified in general by the reference numeral 20.

The shoe 20 includes a Vamp 1 with certain color, Quarter 2 being a different or the same piece and/or color, Heel Counter 3 being a different or the same piece and/or color, Tongue 4 being the same or different color. In addition, Tongue Binder 5, Foxing 7, Foxing Stripe 8, Collar Lining 6, Shoe Laces 9, Shoe Lace Eyelets 10, Logo Tag 11, may each have its own different color from each other or the same as one or more other pieces. There could be a socket 30 located at a place either inside or outside the shoe 20, with an exemplary location at the back of the Foxing 7, which may include a cover protecting the electrical connections of the socket sending signals to various circuits controlling the color change of each e-ink pixel. There could be one or more such sockets located at various positions inside or outside of the shoe. The cover for the socket is preferably water-tight so that the socket remains dry even if the shoe is wet. When the shoe color theme needs to be changed, the shoe can be connected via the socket 30 with an e-ink paper driver that changes the color displays of each pixel on some or all of the e-ink paper. Such a driver includes power source either via its own battery supply or via connection to a fixed power supply. For simple designs, each section covering 1, 2, 3, 4, 5, 6, 7, 8, 9, 10, 11 may be the same color theme or pattern. This means that the e-ink paper of each section can be all connected as if a single piece and display a single color or a simple design pattern/color theme. For more complex design patterns, each section itself has an individual design/color theme for the corresponding e-ink paper piece with the same or different resolution. The designer can vary each piece to obtain a very complex color/pattern scheme for each section on the apparel. Alternatively, some sections may be one color and controllable by one single switch, while other sections are complex structure with each pixel being controlled by a unique switch. Such design will allow extremely complicated colorful graphical design of the shoe surface. When the socket 30 is connected with the driver which loads a newly designed picture onto the circuit behind socket 30, and via the power supplied by the driver battery or from its connection to an external power source, then all color pixels of the e-ink paper is adjusted according to the newly designed picture. This is the only time power consumption happens. After the switching of e-ink paper is completed, the driver is unplugged from socket 30, and e-ink paper no longer consumes any power, yet the picture will remain unchanged. If the shoe needs to be changed to another pattern later, a new design can be loaded into the driver and upload into the shoe via socket 30, and change the shoe into a completed different pattern. Again, power is only needed during the switching of the picture, and not needed at all after socket 30 is unplugged and thus avoids consuming power during static condition.

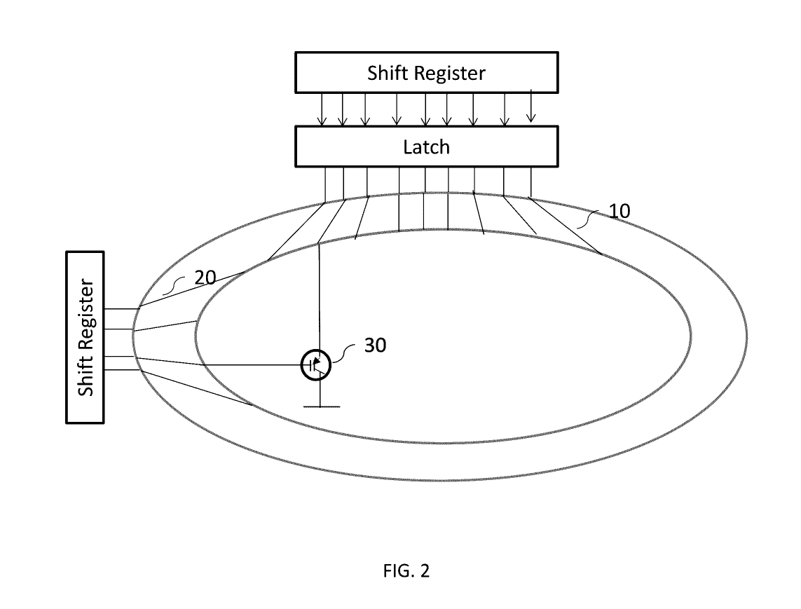

FIG. 2 shows a display matrix control circuit, illustrating how is each pixel controlled by external signals. Lines 10 are connections to source drivers which are active at the same time and connected to a common voltage. Lines 20 are connections to gate drivers, which are active one at a time to turn on each pixel or off. There is a gate driver connected to each single pixel. If the pixel is designed to be at certain color, the gate driver will switch to the proper state to induce such a color either by combinations of color or different value of voltage applied to the thin film transistor (TFT) field effect transistor (FET). After a pixel is driven to display the intended color, gate driver can turn off, and no electricity will flow through the TFT FET and thus the display consumes little or no power.

With the technology advancement, wireless charging has become readily available. Therefore, socket 30 may no longer be needed in order to power up the driver to drive each pixel. One embodiment is including a battery in the apparel and wireless charge up the battery. Then the apparel can utilize the battery power to activate each pixel driver. For example, a person can simply put the apparel on or near or wireless charging station/source to charge up battery for the apparel.

Other embodiments include charging up the local battery in the apparel using solar energy from the sun or converting kinetics energy exerted on the apparel to electrical energy to be stored in the battery. Such kinetics energy could be generated, for example, by pressure on the shoe as the person walks, energy stored into the battery by the swinging arms of the person, etc.

When the apparel has its own battery, additional embodiments can be implemented for communication from the design device to the apparel. For example, the newly designed pattern can be transferred wirelessly, rather than via the physical connection via the socket 30. For example, a new pattern of shoe design on a smart phone can be sent to the shoe either wirelessly via Bluetooth, LTE, WiFi, cellular, radio wave, acoustic energy, infra-red lights, or through other wireless communication mechanisms. Of course, certain communication protocols must be established so that only designated devices can access the apparel pixel driver.

While the present invention has been described above in terms of specific embodiments, it is to be understood that the invention is not limited to these disclosed embodiments. Many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

We claim:

1. A customizable apparel comprising;
a flexible display with plurality of pixels;
an electrical driver driving one of the pixels;
a socket positioned in the apparel and connected with the driver; and
the driver causing the pixel to change color after the socket is connected with an external power source.

2. The customizable apparel as in claim 1, where the flexible display comprises e-ink paper.

3. The customizable apparel as in claim 1, where the apparel is a shoe, backpack, tie, belt, jacket, or skirt.

4. The customizable apparel as in claim 2, where the apparel is a shoe, backpack, tie, belt, jacket, or skirt.

5. The customizable apparel as in claim 1, the pixel's change of color is caused by an instruction from another device.

6. The customizable apparel as in claim 5, where the instruction is received wirelessly through Bluetooth, cellular, wifi, radio frequency, infra-red light, or acoustically.

7. A customizable apparel comprising;
a flexible display with plurality of pixels;
an electrical driver driving one of the pixels;
the driver capable of receiving instructions wirelessly; and
the driver causing the pixel to change color as a result of the instruction.

8. The customizable apparel as in claim 7, where the flexible display comprises e-ink paper.

9. The customizable apparel as in claim 7, where the apparel further comprises a battery.

10. The customizable apparel as in claim 7, where the apparel is a shoe, backpack, tie, belt, jacket, or skirt.

11. The customizable apparel as in claim 9, where is battery is powered by a wireless charger, the kinetic energy from the apparel wearer, or a solar cell.

12. The customizable apparel as in claim 7, where the wireless communication is through Bluetooth, cellular, wifi, radio frequency, infra-red light, or acoustic.

13. A method to customize an apparel comprising;
displaying a color design on a flexible display with plurality of pixels, with one or more pixels connecting to an electrical driver;
receiving an instruction by the driver; and
the driver causing the pixel to change color.

14. The method to customize an apparel as in claim 13, where the instruction was received via wireless communication.

15. The method to customize an apparel as in claim 14, where the apparel further comprises a battery which powers the driver.

16. The method to customize an apparel as in claim 13, further comprising the driver connecting to an external power source prior to receiving the instruction.

17. The method to customize an apparel as in claim 16, where the instruction was received via wireless communication.

18. The method to customize an apparel as in claim 16, where the socket is a shoe, backpack, tie, belt, jacket, or skirt.

19. The method to customize an apparel as in claim 16, where the flexible display is an e-ink paper.
